(19) United States
(12) Patent Application Publication
(10) Pub. No.: US 2026/0162613 A1
(43) Pub. Date: Jun. 11, 2026

(54) DISPLAY DEVICE AND METHOD OF DRIVING SAME

(71) Applicant: LG Display Co., Ltd., Seoul (KR)

(72) Inventors: Jae Hee PARK, Paju-si (KR); Sung Hee PARK, Paju-si (KR)

(73) Assignee: LG Display Co., Ltd., Seoul (KR)

(21) Appl. No.: 19/371,544

(22) Filed: Oct. 28, 2025

(30) Foreign Application Priority Data
Dec. 10, 2024 (KR) 10-2024-0183029

(51) Int. Cl. G09G 3/3233; G09G 3/32

(52) U.S. Cl. CPC G09G 3/3233; G09G 3/32; G09G 2300/0452; G09G 2300/0465; G09G 2300/0819; G09G 2300/0842; G09G 2310/0286; G09G 2310/08; G09G 2320/045

(57) ABSTRACT

A display device includes a display panel configured to display an image, a gate driver connected to gate lines of the display panel, and a data driver connected to data lines of the display panel. The display panel may operate in a period during which a display data voltage is stored based on three scan signals sequentially applied through three scan lines included in one gate line during one horizontal time, and a source node is initialized based on an initialization data voltage. A method of driving a display device is also disclosed.

### CROSS-REFERENCE TO RELATED APPLICATIONS

This application claims the benefit of and priority to Korean Patent Application No. 10-2024-0183029, filed on Dec. 10, 2024, the entire contents of which are incorporated herein by reference for all purposes.

### BACKGROUND

### 1. Technical Field

The present disclosure relates to a display device and a method of driving the same.

### 2. Description of Related Art

As information technology develops, the market for display devices serving as connecting media between users and information, is growing. Accordingly, the use of display devices such as light emitting display (LED) devices, quantum dot display (QDD) devices, and liquid crystal display (LCD) devices is increasing.

The display devices described above include a display panel including subpixels, a driver that outputs a driving signal to drive the display panel, and a power supply that generates power to be supplied to the display panel or the driver.

The display devices described above can display images by allowing selected subpixels to transmit light or directly emit light when driving signals, such as a scan signal and a data signal, are supplied to the subpixels formed on the display panel.

The description of related art should not be considered prior art merely because it is mentioned in or associated with this section. The description of related art includes information that describes one or more aspects of the subject technology, and the description in this section does not limit the scope of the present disclosure.

### SUMMARY

Accordingly, one or more aspects of the present disclosure are directed to a display device and a method of driving the same that substantially obviate one or more problems due to limitations and disadvantages of the related art.

An aspect of the present disclosure is to reduce the manufacturing cost of a display device by eliminating a voltage generation circuit that generates and outputs an initialization voltage and to achieve both an improved aperture ratio and a reduced bezel size by eliminating voltage lines for applying the initialization voltage to a display panel or reducing the number of voltage lines.

Additional advantages, aspects, and features of the present disclosure will be set forth in part in the description which follows and in part will become apparent to those having ordinary skill in the art upon examination of the following or may be learned from practice of the present disclosure. The objectives and other advantages of the present disclosure may be realized and attained by the structure particularly pointed out in the written description and claims hereof as well as the appended drawings.

To achieve these aspects and other advantages and in accordance with the purpose of the present disclosure, as embodied and broadly described herein, a display device includes a display panel configured to display an image, a gate driver connected to gate lines of the display panel, and a data driver connected to data lines of the display panel, wherein the display panel is configured to operate in a period during which a display data voltage is stored based on three scan signals sequentially applied through three scan lines included in one gate line during one horizontal time, and a source node is initialized based on an initialization data voltage.

The display panel may include a first subpixel for storing the display data voltage and initializing the source node based on the initialization data voltage, the display data voltage may be a data voltage applied through a first data line connected to the first subpixel, and the initialization data voltage may include a data voltage applied through a second data line connected to a second subpixel adjacent to the first subpixel.

The display panel may include a first pixel including four subpixels connected to second and third scan lines among the three scan lines, and a second pixel including four subpixels connected to first scan line and the second scan line among the three scan lines.

The first pixel may include a first subpixel connected to the second scan line and connected to a first data line and a third data line, a second subpixel connected to the second scan line and connected to a second data line and a fourth data line, a third subpixel connected to the third scan line and connected to the third data line and the first data line, and a fourth subpixel connected to the third scan line and connected to the fourth data line and the second data line.

The first subpixel may store the display data voltage applied through the first data line in a capacitor and initialize a source node based on the initialization data voltage applied through the third data line, the second subpixel may store the display data voltage applied through the second data line in a capacitor and initialize a source node based on the initialization data voltage applied through the fourth data line, the third subpixel may store the display data voltage applied through the third data line in a capacitor and initialize a source node based on the initialization data voltage applied through the first data line, and the fourth subpixel may store the display data voltage applied through the fourth data line in a capacitor and initialize a source node based on the initialization data voltage applied through the second data line.

The second pixel may include a first subpixel connected to the first scan line and connected to a first data line and a third data line, a second subpixel connected to the first scan line and connected to a second data line and a fourth data line, a third subpixel connected to the second scan line and connected to the third data line and the first data line, and a fourth subpixel connected to the second scan line and connected to the fourth data line and the second data line.

The display panel may include a red subpixel and a green subpixel configured to start operation during a first period of time for which a first scan signal is applied, a red subpixel, a green subpixel, a blue subpixel, and a white subpixel configured to start operation during a second period of time for which a second scan signal is applied, and a blue subpixel and a white subpixel configured to start operation during a third period of time for which a third scan signal is applied.

In another aspect of the present disclosure, a method of driving a display device includes applying a first scan signal through a first scan line included in one gate line and driving a first subpixel and a second subpixel included in a second pixel, applying a second scan signal through a second scan line included in the gate line and driving a first subpixel and a second subpixel included in a first pixel and a third subpixel and a fourth subpixel included in the second pixel, and applying a third scan signal through a third scan line included in the gate line and driving a third subpixel and a fourth subpixel included in the first pixel, wherein the first pixel and the second pixel store a display data voltage based on the first scan signal, the second scan signal, and the third scan signal sequentially applied for one horizontal time and initialize a node based on an initialization data voltage.

The display data voltage may be a data voltage applied through a first data line, and the initialization data voltage may include a data voltage applied through a second data line adjacent to the first data line.

The first pixel may include a first subpixel connected to the second scan line and connected to a first data line and a third data line, a second subpixel connected to the second scan line and connected to a second data line and a fourth data line, a third subpixel connected to the third scan line and connected to the third data line and the first data line, and a fourth subpixel connected to the third scan line and connected to the fourth data line and the second data line.

It is to be understood that both the foregoing general description and the following detailed description of the present disclosure are examples and explanatory and are intended to provide further explanation of the present disclosure as claimed.

### BRIEF DESCRIPTION OF THE DRAWINGS

The accompanying drawings, which are included to provide a further understanding of the present disclosure, are incorporated in and constitute a part of this present disclosure, illustrate aspects and embodiments of the present disclosure, and together with the description serve to explain principles and examples of the disclosure. In the drawings:

FIG. 1 is a block diagram schematically showing a light-emitting display device, and FIG. 2 and FIG. 3 are diagrams illustrating a configuration of a gate-in-panel type gate driver;

FIG. 4 is a diagram showing a circuit configuration of a subpixel according to an embodiment, and FIG. 5 is a diagram for describing a subpixel compensation method according to an embodiment;

FIG. 6 shows pixel layout and connection in a display panel according to an embodiment, and FIG. 7 shows gate signal waveforms for driving the display panel shown in FIG. 6;

FIG. 8 to FIG. 10 are diagrams illustrating operation states of the display panel according to the gate signal waveforms of FIG. 7;

FIG. 11 is a diagram showing a circuit configuration of two subpixels included in a first pixel in FIG. 8 according to an embodiment, FIG. 12 and FIG. 13 are diagrams showing operation states of the subpixels and driving waveforms therefor for describing data voltage writing and initialization operations, and FIG. 14 and FIG. 15 are diagrams showing operation states of the subpixels and driving waveforms therefor for describing an emission operation; and

FIG. 16 is a diagram showing a configuration of a data driver according to an embodiment and output forms of a data voltage output from the data driver.

Throughout the drawings and the detailed description, unless otherwise described, the same drawing reference numerals should be understood to refer to the same elements, features, and structures. The sizes, lengths, and thicknesses of layers, regions and elements, and depiction thereof may be exaggerated for clarity, illustration, and/or convenience.

### DETAILED DESCRIPTION

Reference is now made in detail to embodiments of the present disclosure, examples of which may be illustrated in the accompanying drawings. In the following description, when a detailed description of well-known methods, functions, structures or configurations may unnecessarily obscure aspects of the present disclosure, the detailed description thereof may have been omitted for brevity. Further, repetitive descriptions may be omitted for brevity. The progression of processing steps and/or operations described is a non-limiting example.

The sequence of steps and/or operations is not limited to that set forth herein and may be changed to occur in an order that is different from an order described herein, with the exception of steps and/or operations necessarily occurring in a particular order. In one or more examples, two operations in succession may be performed substantially concurrently, or the two operations may be performed in a reverse order or in a different order depending on a function or operation involved.

Unless stated otherwise, like reference numerals may refer to like elements throughout even when they are shown in different drawings. Unless stated otherwise, the same reference numerals may be used to refer to the same or substantially the same elements throughout the specification and the drawings. In one or more aspects, identical elements (or elements with identical names) in different drawings may have the same or substantially the same functions and properties unless stated otherwise. Names of the respective elements used in the following explanations are selected only for convenience and may be thus different from those used in actual products.

Advantages and features of the present disclosure, and implementation methods thereof, are clarified through the embodiments described with reference to the accompanying drawings. The present disclosure may, however, be embodied in different forms and should not be construed as limited to the embodiments set forth herein. Rather, these embodiments are examples and are provided so that this disclosure may be thorough and complete to assist those skilled in the art to understand the inventive concepts without limiting the protected scope of the present disclosure.

Shapes, dimensions (e.g., sizes, lengths, widths, heights, thicknesses, locations, radii, diameters, and areas), proportions, ratios, angles, numbers, the number of elements, and the like disclosed herein, including those illustrated in the drawings, are merely examples, and thus, the present disclosure is not limited to the illustrated details. It is, however, noted that the relative dimensions of the components illustrated in the drawings are part of the present disclosure.

When the term “comprise,” “have,” “include,” “contain,” “constitute,” “made of,” “formed of,” “composed of,” or the like is used with respect to one or more elements (e.g., layers, films, components, electrodes, structures, transistors, sections, members, parts, regions, areas, portions, steps, operations, and/or the like), one or more other elements may be added unless a term such as “only” or the like is used. The terms used in the present disclosure are merely used in order to describe particular example embodiments, and are not intended to limit the scope of the present disclosure. Any references to singular may include plural, and vice versa, unless expressly stated otherwise. In one or more examples, unless expressly stated otherwise, an element may be one or more elements; and an element may include a plurality of elements. The word “exemplary” is used to mean serving as an example or illustration. Embodiments are example embodiments. Aspects are example aspects. In one or more implementations, “embodiments,” “examples,” “aspects,” and the like should not be construed to be preferred or advantageous over other implementations. An embodiment, an example, an example embodiment, an aspect, or the like may refer to one or more embodiments, one or more examples, one or more example embodiments, one or more aspects, or the like, unless stated otherwise. Further, the term “may” encompasses all the meanings of the term “can.”

In one or more aspects, unless explicitly stated otherwise, an element, feature, or corresponding information (e.g., a level, range, dimension, size, or the like) is construed to include an error or tolerance range even where no explicit description of such an error or tolerance range is provided. An error or tolerance range may be caused by various factors (e.g., process factors, internal or external impact, noise, or the like). In interpreting a numerical value, the value is interpreted as including an error range unless explicitly stated otherwise.

When a positional relationship between two elements (e.g., layers, films, components, electrodes, structures, transistors, sections, members, parts, regions, areas, portions, and/or the like) are described using any of the terms such as “on,” “on a top of,” “upon,” “on top of,” “over,” “under,” “above,” “upper,” “at an upper portion,” “at a upper side,” “below,” “lower,” “at a lower portion,” “at a lower side,” “beneath,” “near,” “close to,” “adjacent to,” “beside,” “next to,” “at or on a side of,” and/or the like indicating a position or location, one or more other elements may be located between the two elements unless a more limiting term, such as “immediate(ly),” “direct(ly),” or “close(ly),” is used. For example, when an element and another element are described using any of the foregoing terms, this description should be construed as including a case in which the elements contact each other directly as well as a case in which one or more additional elements are disposed or interposed therebetween. Furthermore, the spatially relative terms such as the foregoing terms as well as other terms such as “front,” “rear,” “back,” “left,” “right,” “top,” “bottom,” “upper,” “lower,” “downward,” “upward,” “up,” “down,” “column,” “row,” “vertical,” “horizontal,” “diagonal,” and the like refer to an arbitrary frame of reference. For example, these terms may be used for an example understanding of a relative relationship between elements, including any correlation as shown in the drawings. However, embodiments of the disclosure are not limited thereby or thereto. The spatially relative terms are to be understood as terms including different orientations of the elements in use or in operation in addition to the orientation depicted in the drawings or described herein. For example, where a lower element or an element positioned under another element is overturned, then the element may be termed as an upper element or an element positioned above another element. Thus, for example, the term “under” or “beneath” may encompass, in meaning, the term “above” or “over.” An example term “below” or the like, can include all directions, including directions of “below,” “above” and diagonal directions. Likewise, an example term “above,” “on” or the like can include all directions, including directions of “above,” “on,” “below” and diagonal directions.

In describing a temporal relationship, when the temporal order is described as, for example, “after,” “following,” “subsequent,” “next,” “before,” “preceding,” “prior to,” or the like, a case that is not consecutive or not sequential may be included and thus one or more other events may occur therebetween, unless a more limiting term, such as “just,” “immediate(ly),” or “direct(ly),” is used.

It is understood that, although the terms “first,” “second,” and the like may be used herein to describe various elements (e.g., layers, films, components, electrodes, structures, transistors, sections, members, parts, regions, areas, portions, steps, operations, and/or the like), these elements should not be limited by these terms, for example, to any particular order, precedence, or number of elements. These terms are merely used to refer to one element separately from another. For example, a first element may denote a second element, and, similarly, a second element may denote a first element, without departing from the scope of the present disclosure. Furthermore, the first element, the second element, and the like may be arbitrarily named according to the convenience of those skilled in the art without departing from the scope of the present disclosure. For clarity, the functions or structures of these elements (e.g., the first element, the second element, and the like) are not limited by ordinal numbers or the names in front of the elements. Further, a first element may include one or more first elements. Similarly, a second element or the like may include one or more second elements or the like.

In describing elements of the present disclosure, the terms “first,” “second,” “A,” “B,” “(a),” “(b),” or the like may be used. These terms are intended to identify the corresponding element(s) from the other element(s), and these are not used to define the essence, basis, order, or number of the elements.

The expression that an element (e.g., layer, film, component, electrode, structure, transistor, section, member, part, region, area, portion, or the like) “is engaged” with another element may be understood, for example, as that the element may be either directly or indirectly engaged with the another element. The term “is engaged” or similar expressions may refer to a term such as “covers,” “surrounds,” “is in contact,” “overlaps,” “crosses,” “intersects,” “is connected,” “is coupled,” “is attached,” “is adhered,” “is combined,” “is linked,” “is provided,” “is disposed,” “interacts,” or the like. The engagement may involve one or more intervening elements disposed or interposed between the element and the another element, unless otherwise specified. Further, the element may be engaged at least partially or entirely (or completely) with the another element, unless otherwise specified. Further, the element may be included in at least one of two or more elements that are engaged with each other. Similarly, the another element may be included in at least one of two or more elements that are engaged with each other. When the element is engaged with the another element, at least a portion of the element may be engaged with at least a portion of the another element. The term “with another element” or similar expressions may be understood as “another element,” or “with, to, in, or on another element,” as appropriate by the context. Similarly, the term “with each other” may be understood as “each other,” or “with, to, or on each other,” as appropriate by the context.

The terms such as a “line” or “direction” should not be interpreted only based on a geometrical relationship in which the respective lines or directions are parallel, perpendicular, diagonal, or slanted with respect to each other, and may be meant as lines or directions having wider directivities within the range within which the components of the present disclosure may operate functionally.

The term “at least one” should be understood as including any and all combinations of one or more of the associated listed items. For example, each of the phrases “at least one of a first item, a second item, or a third item” and “at least one of a first item, a second item, and a third item” may represent (i) a combination of items provided by two or more of the first item, the second item, and the third item or (ii) only one of the first item, the second item, or the third item. Further, at least one of a plurality of elements can represent (i) one element of the plurality of elements, (ii) some elements of the plurality of elements, or (iii) all elements of the plurality of elements. Further, “at least some,” “some,” “at least some portions,” “at least some parts,” “at least a portion,” “at least one or more portions,” “at least a part,” “at least one or more parts,” “at least some elements,” “one or more,” or the like of a plurality of elements can represent (i) one element of the plurality of elements, (ii) a portion (or a part) of the plurality of elements, (iii) one or more portions (or parts) of the plurality of elements, (iv) one or more elements of the plurality of elements, (v) multiple elements of the plurality of elements, or (vi) all of the plurality of elements. Moreover, “at least some,” “some,” “at least some portions,” “at least some parts,” “at least a portion,” “at least one or more portions,” “at least a part,” “at least one or more parts,” or the like of an element can represent (i) a portion (or a part) of the element, (ii) one or more portions (or parts) of the element, (iii) the element, or (iv) all portions of the element.

The expression of a first element, a second elements “and/or” a third element should be understood as any one of the first, second and third elements or as any or all combinations of the first, second and third elements. Similar interpretations apply to the use of “and/or” with two elements or with more than three elements. By way of example, A, B and/or C may refer to only A; only B; only C; any of A, B, and C (e.g., A, B, or C); some combination of A, B, and C (e.g., A and B; A and C; or B and C); or all of A, B, and C. Furthermore, an expression “A/B” may be understood as A and/or B. For example, an expression “A/B” may refer to only A; only B; A or B; or A and B.

In one or more aspects, the terms “between” and “among” may be used interchangeably simply for convenience unless stated otherwise. For example, an expression “between a plurality of elements” may be understood as among a plurality of elements. In another example, an expression “among a plurality of elements” may be understood as between a plurality of elements. In one or more examples, the number of elements may be two. In one or more examples, the number of elements may be more than two. Furthermore, when an element is referred to as being “between” at least two elements, the element may be the only element between the at least two elements, or one or more intervening elements may also be present.

In one or more aspects, the phrases “each other” and “one another” may be used interchangeably simply for convenience unless stated otherwise. For example, an expression “different from each other” may be understood as being different from one another. In another example, an expression “different from one another” may be understood as being different from each other. In one or more examples, the number of elements involved in the foregoing expression may be two. In one or more examples, the number of elements involved in the foregoing expression may be more than two.

In one or more aspects, the phrases “one or more among” and “one or more of” may be used interchangeably simply for convenience unless stated otherwise.

The term “or” means “inclusive or” rather than “exclusive or.” That is, unless otherwise stated or clear from the context, the expression that “x uses a or b” means any one of natural inclusive permutations. For example, “a or b” may mean “a,” “b,” or “a and b.” For example, “a, b or c” may mean “a,” “b,” “c,” “a and b,” “b and c,” “a and c,” or “a, b and c.”

A phrase “substantially the same” or “nearly the same” may indicate a degree of being considered as being equivalent to each other taking into account minute differences due to errors in the manufacturing process.

Features of various embodiments of the present disclosure may be partially or entirely coupled to or combined with each other, may be technically associated with each other, and may be variously operated, linked or driven together in various ways. Embodiments of the present disclosure may be implemented or carried out independently of each other or may be implemented or carried out together in a co-dependent or related relationship. In one or more aspects, the components of each apparatus and device according to various embodiments of the present disclosure are operatively coupled and configured.

Unless otherwise defined, the terms (including technical and scientific terms) used herein have the same meaning as commonly understood by one of ordinary skill in the art to which example embodiments belong. It is further understood that terms, such as those defined in commonly used dictionaries, should be interpreted as having a meaning that is, for example, consistent with their meaning in the context of the relevant art and should not be interpreted in an idealized or overly formal sense unless expressly defined otherwise herein. For example, the term “part” or “unit” may apply, for example, to a separate circuit, component or structure, an integrated circuit, a computational block of a circuit device, or a structure configured to perform a described function as should be understood by one of ordinary skill in the art.

The terms used herein have been selected as being general in the related technical field; however, there may be other terms depending on the development and/or change of technology, convention, preference of technicians, and so on. Therefore, the terms used herein should not be understood as limiting technical ideas, but should be understood as examples of the terms for describing example embodiments.

Further, in a specific case, a term may be arbitrarily selected by an applicant, and in this case, the detailed meaning thereof is described herein. Therefore, the terms used herein should be understood based on not only the name of the terms, but also the meaning of the terms and the content hereof.

In the following description, various example embodiments of the present disclosure are described in more detail with reference to the accompanying drawings. With respect to reference numerals to elements of each of the drawings, the same or similar elements may be illustrated in other drawings, and like reference numerals may refer to like or similar elements unless stated otherwise. The same or similar elements may be denoted by the same reference numerals even if they are depicted in different drawings. Repetitive descriptions of the same or similar elements may be omitted for brevity, and the descriptions provided for elements in one or more figures may also apply to elements in other figures that use the same or similar reference numerals unless stated otherwise. In addition, for the convenience of description, a scale, dimension, size, and thickness of each of the elements illustrated in the accompanying drawings may be different from an actual scale, dimension, size, and thickness, and thus, embodiments of the present disclosure are not limited to a scale, dimension, size, and thickness illustrated in the drawings.

In description of flow of a signal, for example, when a signal is provided (e.g., transferred or transmitted) from a node A to a node B, this may include a case where the signal is provided from the node A to the node B via one or more nodes unless a phrase such as “immediately provided,” “directly provided” or the like is used.

A display device according to the present disclosure may be implemented as a television, a video player, a personal computer (PC), a home theater, an automobile electrical device, a smartphone, or the like, but the present disclosure is not limited thereto. The display device according to the present disclosure may be implemented as a light emitting display (LED) device, a quantum dot display (QDD) device, a liquid crystal display (LCD) device, or the like. However, for convenience of description, a light emitting display device that directly emits light based on inorganic light-emitting diodes or organic light-emitting diodes is used as an example of the display device.

In addition, a transistor which will be described below may be implemented as an n-type transistor, a p-type transistor, or a form including both n-type and p-type transistors. The transistor is a three-electrode element including a gate, a source, and a drain. The source is an electrode that supplies carriers to the transistor. In the transistor, carriers start to flow from the source. The drain is an electrode through which carriers leave the transistor. In other words, carriers flow from the source to the drain in the transistor.

In the case of a p-type transistor, holes serve as carriers, and thus a source voltage is higher than a drain voltage such that the holes can flow from the source to the drain. Since the holes flow from the source to the drain in the p-type transistor, the current flows from the source to the drain. In contrast, in the case of an n-type transistor, electrons serve as carriers, and thus the source voltage is lower than the drain voltage such that the electrons can flow from the source to the drain. Since the electrons flow from the source to the drain in the n-type transistor, the current flows from the drain to the source. However, the source and drain of a transistor can be changed depending on the applied voltage. To reflect this, in the following description, one of the source and drain is described as a first electrode, and the other of the source and drain is described as a second electrode.

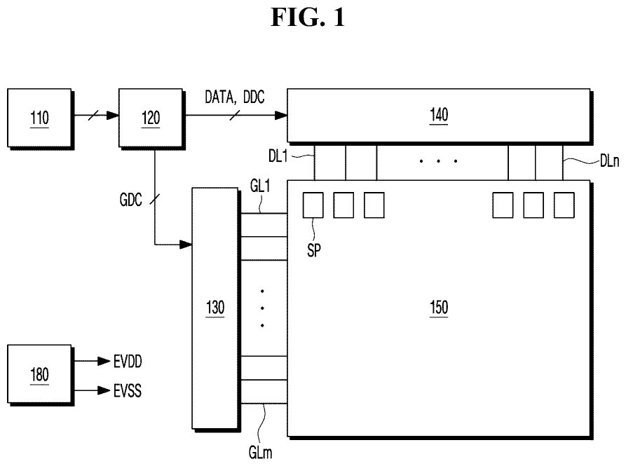

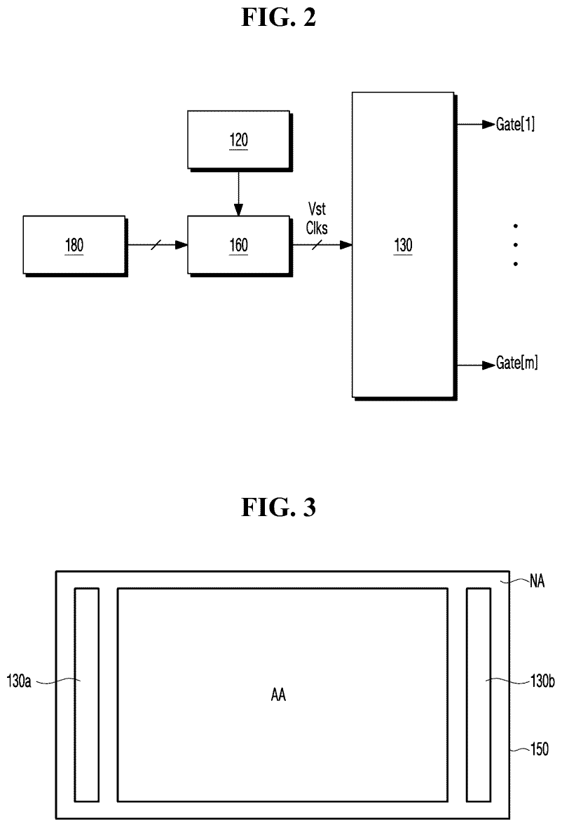

FIG. 1 is a block diagram schematically showing a light-emitting display device, and FIG. 2 and FIG. 3 are diagrams illustrating a configuration of a gate-in-panel type gate driver.

As illustrated in FIG. 1 to FIG. 3, the light-emitting display device may include a timing controller (timing control circuit) 120, a gate driver (gate driving circuit) 130, a data driver (data driving circuit) 140, a display panel 150, and a power supply (power supply circuit) 180.

An image provider (set or host system) 110 may output various driving signals in addition to an image data signal supplied from the outside or an image data signal stored in an internal memory. The image provider 110 may supply a data signal and various driving signals to the timing controller 120.

The timing controller 120 may output a gate timing control signal GDC for controlling the operation timing of the gate driver 130, a data timing control signal DDC for controlling the operation timing of the data driver 140, and various synchronization signals (a vertical synchronization signal Vsync and a horizontal synchronization signal Hsync), etc. The timing controller 120 may supply a data signal DATA supplied from the image provider 110 along with the data timing control signal DDC to the data driver 140. The timing controller 120 may take the form of an integrated circuit (IC) and be mounted on a printed circuit board, but the present disclosure is not limited thereto.

The gate driver 130 may output a gate signal (or a gate voltage) in response to the gate timing control signal GDC supplied from the timing controller 120. The gate driver 130 may supply gate signals to subpixels included in the display panel 150 through gate lines GL1 to GLm. The gate driver 130 may be formed as an IC or directly formed on the display panel 150 in a gate-in-panel structure, but the present disclosure is not limited thereto. However, for convenience of description, a gate-in-panel type gate driver will be described below as an example, as shown in FIG. 2 and FIG. 3.

The gate driver 130 may include shift registers 130a and 130b formed in a gate-in-panel type on one side and the other side of a non-active area NA of the display panel 150. The shift registers 130a and 130b may be formed in the form of a thin film in the gate-in-panel type in the non-active area NA of the display panel 150. The gate-in-panel type gate driver 130 may output gate signals Gate[1] to Gate[m] for turning on or off transistors formed in the active area AA of the display panel 150.

The gate driver 130 may operate based on signals and voltages output from the timing controller 120, the power supply 180, and a level shifter 160. The level shifter 160 may generate gate control signals such as a start signal Vst and a clock signal Clks required for operation of the gate-in-panel type gate driver 130 (130a, and 130b) on the basis of signals and voltages output from the timing controller 120 and the power supply 180.

The data driver 140 may sample and latch a data signal DATA in response to the data timing control signal DDC supplied from the timing controller 120 and convert a digital data signal into an analog data voltage on the basis of a gamma reference voltage and output the analog data voltage. The data driver 140 may supply data voltages to subpixels included in the display panel 150 through data lines DL1 to DLn. The data driver 140 may be formed as an IC and mounted on the display panel 150 or on a printed circuit board, but the present disclosure is not limited thereto.

The power supply 180 may generate a high-level voltage and a low-level voltage based on an external input voltage supplied from the outside, and output the same through a high-level voltage line EVDD and a low-level voltage line EVSS. The power supply 180 may generate and output not only the high-level voltage and the low-level voltage, but also voltages required for operation of the gate driver 130 or voltages required for operation of the data driver 140.

The display panel 150 may be manufactured based on a rigid or flexible substrate such as glass, silicon, or polyimide. The display panel 150 may include a plurality of subpixels SP for displaying an image. The subpixels SP can directly emit light to an upper substrate, a lower substrate, or the upper and lower substrates of the display panel 150. The subpixels SP may emit one of colors, such as red, green, blue, and white of light. The display panel 150 may display an image based on pixels composed of red subpixels, green subpixels, and blue subpixels, or pixels composed of red subpixels, green subpixels, blue subpixels, and white subpixels.

In the above description, the timing controller 120, the gate driver 130, the data driver 140, etc. are described as separate components. However, depending on the implementation of the light-emitting display device, one or more of the timing controller 120, the gate driver 130, and the data driver 140 may be integrated into one IC.

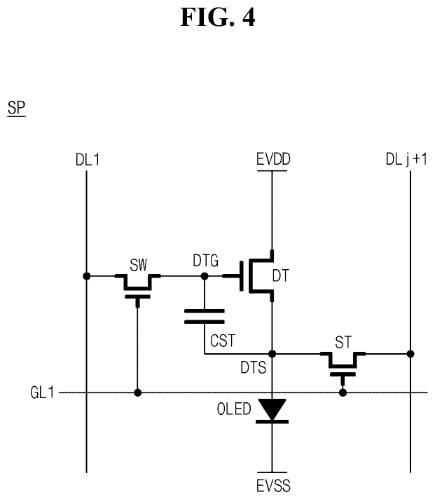

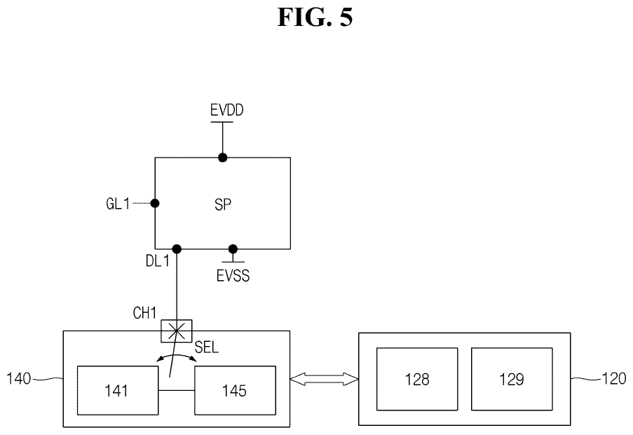

FIG. 4 is a diagram showing a circuit configuration of a subpixel according to an embodiment, and FIG. 5 is a diagram for describing a subpixel compensation method according to an embodiment.

As shown in FIG. 4, a subpixel according to an embodiment may include a switching transistor SW, a sensing transistor ST, a driving transistor DT, a capacitor CST, and a light-emitting diode OLED.

The switching transistor SW may have a gate electrode connected to a first gate line GL1, a first electrode connected to a first data line DL1, and a second electrode connected to a gate node DTG to which a gate electrode of the driving transistor DT and a first electrode of the capacitor CST are connected. The switching transistor SW may be turned on by a first gate signal applied through the first gate line GL1 to transmit a first data voltage applied through the first data line DL1 to the first electrode of the capacitor CST.

The sensing transistor ST may have a gate electrode connected to the first gate line GL1, a first electrode connected to a (J+1)th data line DLj+1, and a second electrode connected to a source node (or sensing node) DTS to which a second electrode of the driving transistor DT, a second electrode of the capacitor CST, and an anode of the light-emitting diode OLED are connected. The sensing transistor ST may be turned on by the first gate signal applied through the first gate line GL1 to transmit a (J+1)th data voltage applied through the (J+1)th data line DLj+1 (j being an integer equal to or greater than 1) to the source node DTS. The sensing transistor ST may also be turned on to sense a threshold voltage of the driving transistor DT or a threshold voltage of the light-emitting diode OLED through the sensing node during a separately defined sensing period.

The driving transistor DT may have the gate electrode connected to the gate node DTG to which the second electrode of the switching transistor SW and the first electrode of capacitor CST are connected, a first electrode connected to a high-level voltage line EVDD, and a second electrode connected to the source node DTS to which the second electrode of the capacitor CST, the second electrode of the sensing transistor ST, and the anode of the light-emitting diode OLED are connected. The driving transistor DT may be turned on by a data voltage stored in the capacitor CST to generate a driving current.

The capacitor CST may have the first electrode connected to the gate node DTG to which the second electrode of the switching transistor SW and the gate electrode of the driving transistor DT are connected, and the second electrode connected to the source node DTS to which the second electrode of the driving transistor DT, the second electrode of the sensing transistor ST, and the anode of the light-emitting diode OLED are connected. The capacitor CST may apply the data voltage stored therein to the gate electrode of the driving transistor DT.

The light-emitting diode OLED may have the anode connected to the source node DTS to which the second electrode of the capacitor CST, the second electrode of the sensing transistor ST, and the second electrode of the driving transistor DT are connected, and a cathode electrode connected to a low-level voltage line EVSS. The light-emitting diode OLED may emit light based on the driving current generated from the driving transistor DT.

The subpixel according to the embodiment stores the first data voltage applied through the first data line DL1 in the capacitor CST during a normal display period and utilizes the (J+1)th data voltage applied through the (J+1)th data line DLj+1 as an initialization voltage for initializing the source node DTS, which will be discussed below.

As illustrated in FIG. 5, according to an embodiment, the data driver 140 may include a first channel CH1 connected to the first data line DL1, a voltage output circuit 141 that outputs a data voltage to be applied to the subpixel SP through the first channel CH1, a pixel sensing circuit 145 that senses an element included in the subpixel SP through the first channel CH1, and a selection switch SEL.

The data driver 140 may control the selection switch SEL such that the first data line DL1 and the voltage output circuit 141 are electrically connected during a normal display period, and then output a data voltage for driving the subpixel SP.

The data driver 140 may control the selection switch SEL such that the first data line DL1 and the pixel sensing circuit 145 are electrically connected during a separately defined sensing period, and then senses an element included in the subpixel SP to obtain a sensing value. At this time, the sensing value may be obtained as a current value or a voltage value.

The data driver 140 may transmit the sensing value sensed during the sensing period to the timing controller 120. The timing controller 120 may compensate for and output a data signal on the basis of the sensing value transmitted from the data driver 140. To this end, the timing controller 120 may further include a deterioration determination unit 128 and a deterioration compensation unit 129.

The deterioration determination unit 128 may determine whether the driving transistor or the light-emitting diode has deteriorated on the basis of a sensing value and output a deterioration value (or a deterioration estimate value) corresponding to deterioration. The deterioration compensation unit 129 may derive a compensation value based on the deterioration value output from the deterioration determination unit and reflect the compensation value in a data signal to be supplied to the data driver 140.

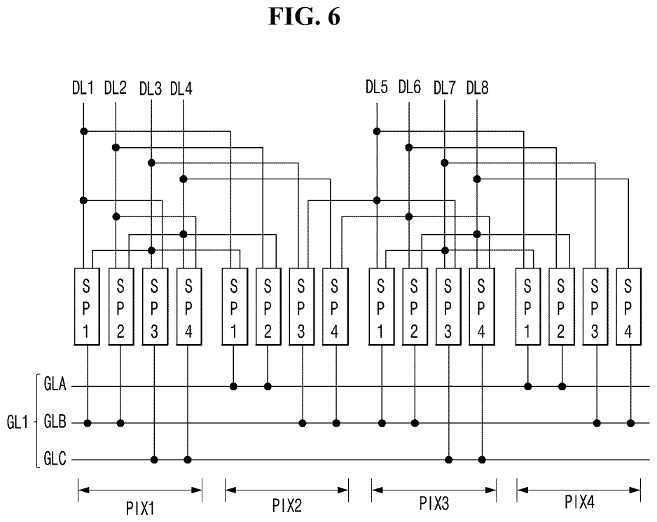

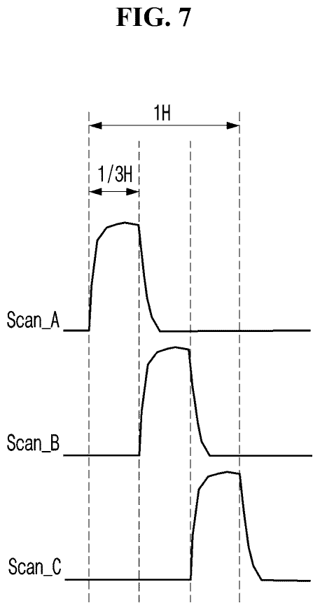

FIG. 6 illustrates pixel layout and connection in a display panel according to an embodiment, and FIG. 7 shows gate signal waveforms for driving the display panel shown in FIG. 6.

As shown in FIG. 6 and FIG. 7, the display panel may be implemented based on pixels PIX1 to PIX4 each including a first subpixel SP1 to a fourth subpixel SP4. The pixels PIX1 to PIX4 may operate based on a first gate signal applied through the first gate line GL1.

The first gate line GL1 may include a first scan line GLA, a second scan line GLB, and a third scan line GLC branched from one gate line. The first scan line GLA may transmit a first scan signal Scan_A, the second scan line GLB may transmit a second scan signal Scan_B, and the third scan line GLC may transmit a third scan signal Scan_C. That is, the first gate signal may include a total of three scan signals, including the first scan signal Scan_A to the third scan signal Scan_C. The display panel may have a period in which a display data voltage is stored based on three scan signals Scan_A to Scan_C sequentially applied through three scan lines GLA to GLC included in one gate line during one horizontal time, and a source node is initialized based on an initialization data voltage.

The first scan signal Scan_A to the third scan signal Scan_C may be generated at a first level (high voltage) for ⅓ horizontal time ⅓H and then maintained at a second level (low voltage). The first scan signal Scan_A to the third scan signal Scan_C may be generated such that periods of time for which they have the first level do not overlap. The first gate signal may be generated during one horizontal time 1H, and the first scan signal Scan_A to the third scan signal Scan C included in the first gate signal may be sequentially generated during ⅓ horizontal time ⅓H.

The first subpixel SP1 and the second subpixel SP2 included in the first pixel PIX1 may be connected to the second scan line GLB, and the third subpixel SP3 and the fourth subpixel SP4 may be connected to the third scan line GLC. The first subpixel SP1 may be connected to a first data line DL1 and a third data line DL3, the second subpixel SP2 may be connected to a second data line DL2 and a fourth data line DL4, the third subpixel SP3 may be connected to the third data line DL3 and the first data line DL1, and the fourth subpixel SP4 may be connected to the fourth data line DL4 and the second data line DL2.

The first subpixel SP1 of the first pixel PIX1 may store a first data voltage applied through the first data line DL1 in a capacitor and utilize a third data voltage applied through the third data line DL3 as an initialization voltage. The second subpixel SP2 of the first pixel PIX1 may store a second data voltage applied through the second data line DL2 in a capacitor and utilize a fourth data voltage applied through the fourth data line DL4 as an initialization voltage. The third subpixel SP3 of the first pixel PIX1 may store a third data voltage applied through the third data line DL3 in a capacitor and utilize the first data voltage applied through the first data line DL1 as an initialization voltage. The fourth subpixel SP4 of the first pixel PIX1 may store the fourth data voltage applied through the fourth data line DL4 in a capacitor and utilize the second data voltage applied through the second data line DL2 as an initialization voltage.

The first subpixel SP1 to the fourth subpixel SP4 included in the third pixel PIX3 may have the same layout and connection relationships as those of the first subpixel SP1 to the fourth subpixel SP4 included in the first pixel PIX1, except that the data lines to which the first subpixel SP1 to the fourth subpixel SP4 are connected are changed from the first data line DL1 to the fourth data line DL4 to a fifth data line DL5 to an eighth data line DL8. Therefore, the description of the first subpixel SP1 to the fourth subpixel SP4 included in the third pixel PIX3 refers to the first subpixel SP1 to the fourth subpixel SP4 included in the first pixel PIX1.

The first subpixel SP1 and the second subpixel SP2 included in the second pixel PIX2 may be connected to the first scan line GLA, and the third subpixel SP3 and the fourth subpixel SP4 included in the second pixel PIX2 may be connected to the second scan line GLB. The first subpixel SP1 may be connected to the first data line DL1 and the third data line DL3, the second subpixel SP2 may be connected to the second data line DL2 and the fourth data line DL4, the third subpixel SP3 may be connected to the third data line DL3 and the fifth data line DL5, and the fourth subpixel SP4 may be connected to the fourth data line DL4 and the sixth data line DL6.

The first subpixel SP1 of the second pixel PIX2 may store the first data voltage applied through the first data line DL1 in a capacitor and utilize the third data voltage applied through the third data line DL3 as an initialization voltage. The second subpixel SP2 of the second pixel PIX2 may store the second data voltage applied through the second data line DL2 in a capacitor and utilize the fourth data voltage applied through the fourth data line DL4 as an initialization voltage. The third subpixel SP3 of the second pixel PIX2 may store the third data voltage applied through the third data line DL3 in a capacitor and utilize a fifth data voltage applied through the fifth data line DL5 as an initialization voltage. The fourth subpixel SP4 of the second pixel PIX2 may store the fourth data voltage applied through the fourth data line DL4 in a capacitor and utilize a sixth data voltage applied through the sixth data line DL6 as an initialization voltage.

The first subpixel SP1 to the fourth subpixel SP4 included in the fourth pixel PIX4 may have the same layout and connection relationships as those of the first subpixel SP1 to the fourth subpixel SP4 included in the second pixel PIX2, except that the data lines to which the first subpixel SP1 to the fourth subpixel SP4 are connected are changed from the first data line DL1 to the sixth data line DL6 to the fifth data line DL5 to the tenth data line (not shown). Therefore, the description of the first subpixel SP1 to the fourth subpixel SP4 included in the fourth pixel PIX4 refers to the first subpixel SP1 to the fourth subpixel SP4 included in the second pixel PIX2.

Hereinafter, an example in which the first subpixel SP1 is selected as a red subpixel, the second subpixel SP2 is selected as a green subpixel, the third subpixel SP3 is selected as a blue subpixel, and the fourth subpixel SP4 is selected as a white subpixel will be described. However, this is merely an example to aid in understanding and the present disclosure is not limited thereto.

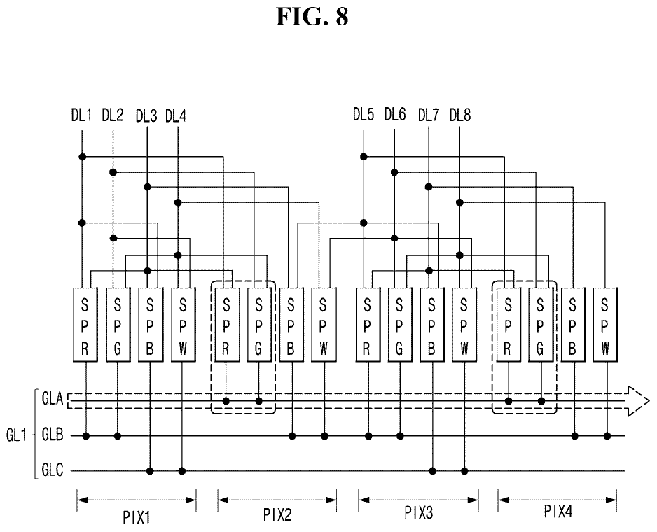

FIG. 8 to FIG. 10 are diagrams showing operation states of the display panel according to gate signal waveforms shown in FIG. 7.

As shown in FIG. 7 and FIG. 8, when the first scan signal Scan_A is applied through the first scan line GLA included in the first gate line GL1, the red subpixel SPR and the green subpixel SPG included in the second pixel PIX2 and the fourth pixel PIX4 can start operation.

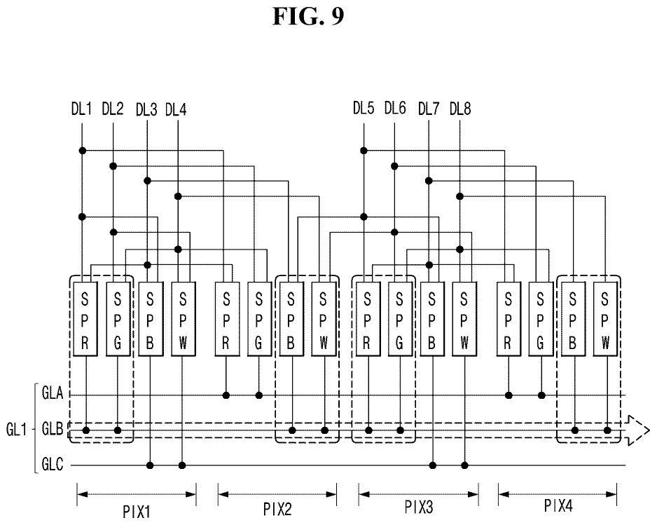

As shown in FIG. 7 and FIG. 9, when the second scan signal Scan_B is applied through the second scan line GLB included in the first gate line GL1, the red subpixel SPR and the green subpixel SPG included in the first pixel PIX1, the blue subpixel SPB and the white subpixel SPW included in the second pixel PIX2, the red subpixel SPR and the green subpixel SPG included in the third pixel PIX3, and the blue subpixel SPB and the white subpixel SPW included in the fourth pixel PIX4 can start operation.

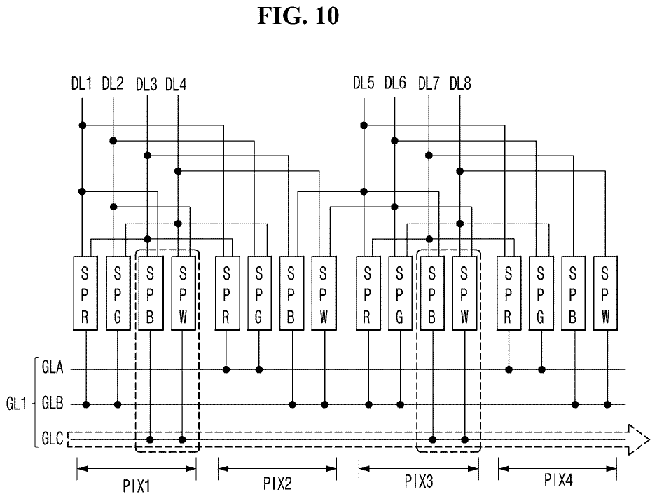

As shown in FIG. 7 and FIG. 10, when the third scan signal Scan_C is applied through the third scan line GLC included in the first gate line GL1, the blue subpixel SPB and the white subpixel SPW included in the first pixel PIX1 and the third pixel PIX3 may start operation.

As can be ascertained from FIG. 8 to FIG. 10, the display panel according to the embodiment may have a first period of time in which two different subpixels operate, a second period of time in which four different subpixels operate (e.g., RGBW), and a third period of time in which two different subpixels operate.

The first period of time may include a driving time of the red subpixel SPR and the green subpixel SPG that start operation due to the first scan signal Scan_A, the second period of time may include a driving time of the red subpixel SPR, the green subpixel SPG, the blue subpixel SPB, and the white subpixel SPW that start operation due to the second scan signal Scan_B, and the third period of time may include a driving time of the blue subpixel SPB and the white subpixel SPW that start operation due to the third scan signal Scan_C.

Meanwhile, the first gate line GL1 sequentially transmits three scan signals through three scan lines during one horizontal time by dividing the horizontal time into ⅓ horizontal times in order to operate the subpixels disposed in one horizontal line. It is noted that the one horizontal time includes the first period of time, the second period of time, and the third period of time.

Hereinafter, a data voltage writing and initialization operation and an emission operation performed during the display period based on the red subpixel SPR and the blue subpixel SPB included in the first pixel PIX1 in FIG. 8 will be described in more detail as follows.

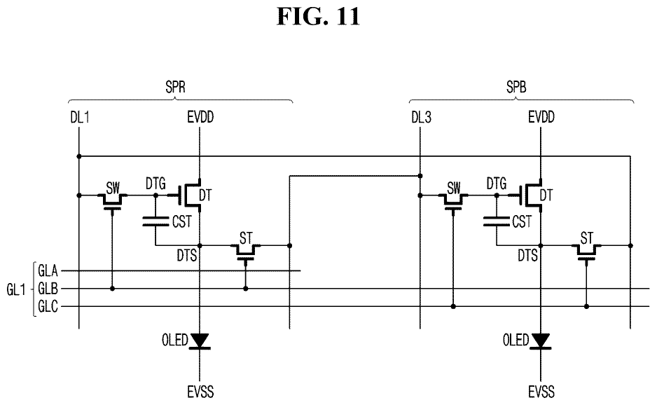

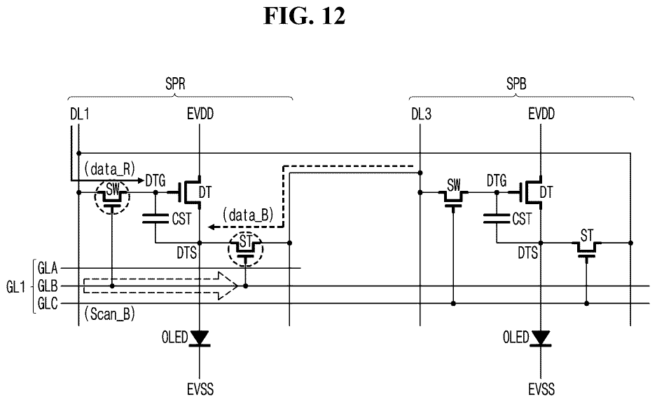

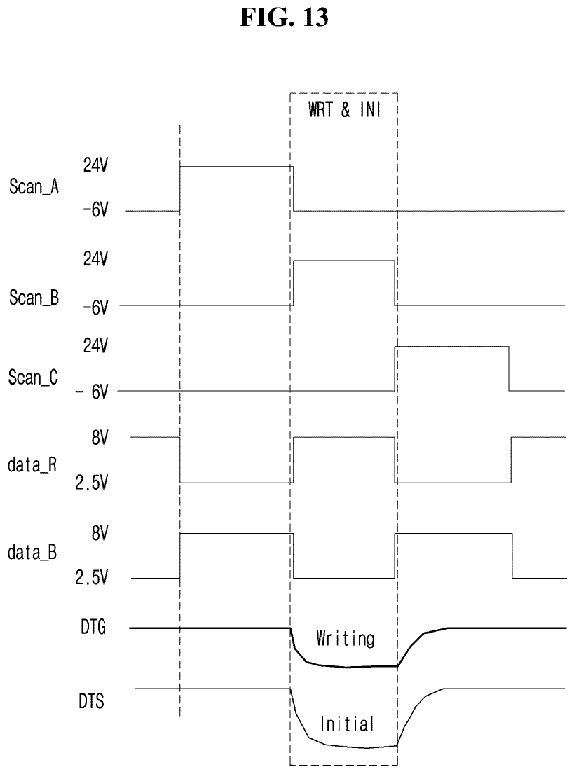

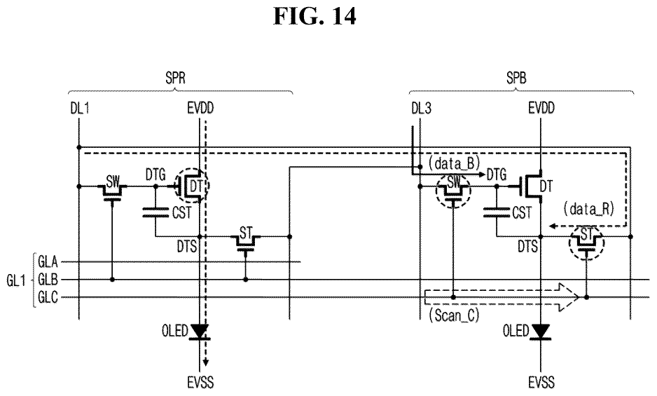

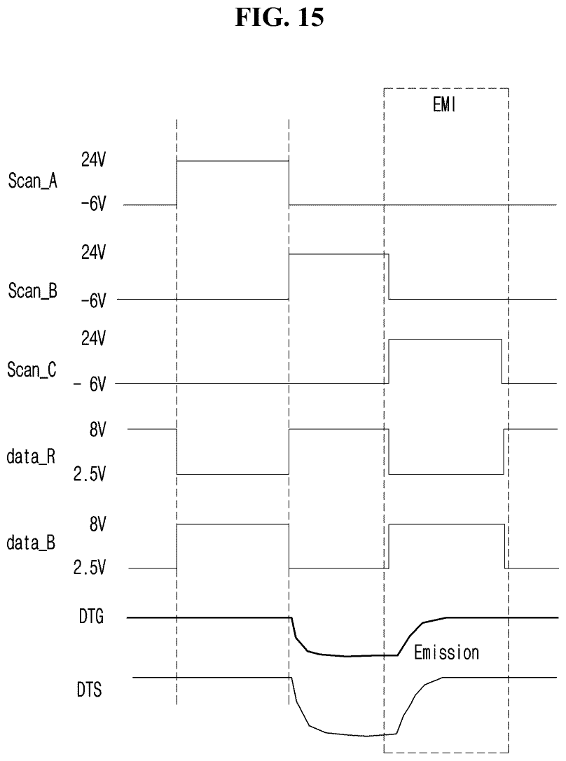

FIG. 11 is a diagram showing a circuit configuration of two subpixels included in the first pixel in FIG. 8 according to an embodiment, FIG. 12 and FIG. 13 are diagrams showing operation states of the subpixels and driving waveforms therefor for describing the data voltage writing and initialization operation, and FIG. 14 and FIG. 15 are diagrams showing operating states of the subpixels and driving waveforms therefor for describing the emission operation.

As illustrated in FIG. 11, the switching transistor SW of the red subpixel SPR may have a first electrode connected to the first data line DL1 and a gate electrode connected to the second scan line GLB. The sensing transistor ST of the red subpixel SPR may have a first electrode connected to the third data line DL3 and a gate electrode connected to the second scan line GLB.

The switching transistor SW of the blue subpixel SPB may have a first electrode connected to the third data line DL3 and a gate electrode connected to the third scan line GLC, and the sensing transistor ST of the blue subpixel SPB may have a first electrode connected to the first data line DL1 and a gate electrode connected to the third scan line GLC. Hereinafter, refer to FIG. 4 for connection relationships of elements not described in the red subpixel SPR and the blue subpixel SPB.

As illustrated in FIG. 12 and FIG. 13, when the second scan signal Scan_B at a high voltage is applied through the second scan line GLB, a first red data voltage data_R can be applied through the first data line DL1 of the red subpixel SPR. The first red data voltage data_R can be transmitted to the gate node DTG through the turned-on switching transistor SW of the red subpixel SPR.

When the second scan signal Scan_B at the high voltage is applied through the second scan line GLB, a second blue data voltage data_B can be applied through the third data line DL3 of the blue subpixel SPB. The second blue data voltage data_B can be transmitted to the source node DTS through the turned-on sensing transistor ST of the red subpixel SPR.

In this case, the first red data voltage data_R may be utilized as a data voltage stored in the first electrode of the capacitor CST through the gate node DTG included in the red subpixel SPR. On the other hand, the second blue data voltage data_B may be utilized as an initialization voltage for initializing the source node DTS (or electrodes connected to the source node) included in the red subpixel SPR.

As can be seen in FIG. 13, the first red data voltage data_R utilized as a data voltage may have a voltage of, for example, approximately 8 V, whereas the second blue data voltage data B utilized as an initialization voltage may have a voltage of, for example, approximately 2.5 V. That is, the first red data voltage data_R may have a display data voltage range for displaying an image, whereas the second blue data voltage data_B may have an initialization data voltage range for initializing a node (a voltage range that is relatively low compared to the display data voltage range and can initialize the source node).

Due to the voltage difference as described above, a data voltage writing operation (Writing) may occur at the gate node DTG of the red subpixel SPR, whereas an initialization operation (Initial) may occur at the source node DTS.

In this way, the data voltage writing operation (Writing) and the initialization operation (Initial) occur simultaneously in the red subpixel SPR according to the embodiment, which may be referred to as a data voltage writing and initialization phase WRT & INI.

As illustrated in FIG. 14 and FIG. 15, when the second scan signal Scan_B at the high voltage is switched to the second scan signal Scan_B at the low voltage, the driving transistor DT of the red subpixel SPR can initiate operation based on the data voltage stored in the capacitor CST of the red subpixel SPR.

The driving transistor DT of the red subpixel SPR can generate a driving current, and the light-emitting diode OLED can perform an emission operation (Emission) to emit light based on the driving current. The period during which the light-emitting diode OLED of the red subpixel SPR emits light may be referred to as an emission phase EMI.

Meanwhile, when the second scan signal Scan_B applied through the second scan line GLB is switched to the low voltage, the third scan signal Scan_C at a high voltage may be applied through the third scan line GLC.

When the third scan signal Scan_C at the high voltage is applied through the third scan line GLC, a second red data voltage data_R may be applied through the first data line DL1 of the red subpixel SPR. The second red data voltage data_R can be transmitted to the source node DTS through the turned-on sensing transistor ST of the blue subpixel SPR.

When the third scan signal Scan_C at a high voltage is applied through the third scan line GLC, a first blue data voltage data_B may be applied through the third data line DL3 of the blue subpixel SPB. The first blue data voltage data_B can be transmitted to the gate node DTG through the turned-on switching transistor SW of the blue subpixel SPB.

In this case, the first blue data voltage data_B may be utilized as a data voltage stored in the first electrode of the capacitor CST through the gate node DTG included in the blue subpixel SPB. On the other hand, the second red data voltage data_R may be utilized as an initialization voltage for initializing the source node DTS (or electrodes connected to the source node) included in the blue subpixel SPB.

As can be seen in FIG. 15, the first blue data voltage data_B used as the data voltage may have a voltage of, for example, approximately 8 V, whereas the second red data voltage data_R used as the initialization voltage may have a voltage of, for example, approximately 2.5 V. That is, the first blue data voltage data_B may have a display data voltage range for displaying an image, whereas the second red data voltage data_R may have an initialization data voltage range for initializing a node (a voltage range that is relatively low compared to the display data voltage range and can initialize the source node).

As can be ascertained from FIG. 12 to FIG. 15, the red subpixel SPR and blue subpixels SPB disposed adjacent to each other are connected to different scan lines and can use (or use as a mutual reference) the display data voltage and the initialization data voltage by exchanging the same. As a result, a voltage generation circuit that generates and outputs the initialization voltage to apply the initialization voltage to the subpixels can be eliminated, and voltage lines for applying the initialization voltage to the display panel (or the subpixels) can be removed. That is, the embodiment can reduce the manufacturing cost of the display device by removing the voltage generation circuit and can achieve both an improved aperture ratio and a reduced bezel size by reducing the number of voltage lines (wires) on the display panel.

Meanwhile, in FIG. 13 and FIG. 15, the voltage ranges of the scan signals are represented as high voltage: “24 V” and low voltage: “−6 V”, and the voltage ranges of the data voltages are represented as first data voltage (or display data voltage): “8 V” and second data voltage (or initialization data voltage): “2.5 V”, but this is only for the purpose of aiding in understanding and the present disclosure is not limited thereto.

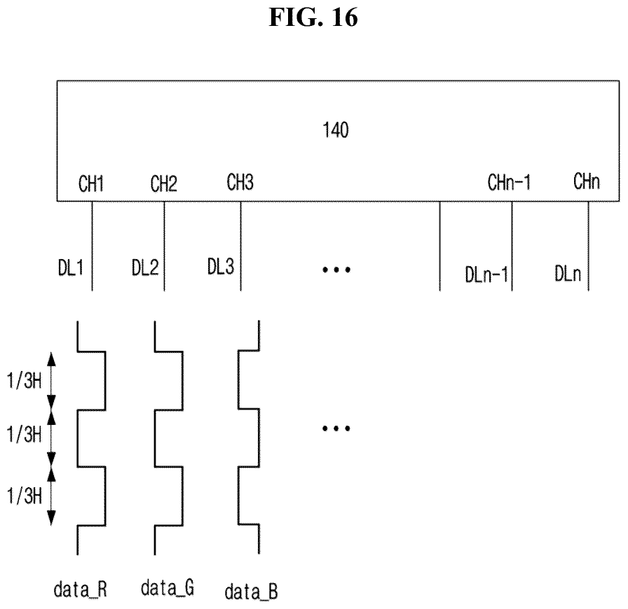

FIG. 16 is a diagram showing a configuration of a data driver according to an embodiment and output forms of a data voltage output from the data driver.

As shown in FIG. 16, the data driver 140 according to the embodiment may output data voltages data_R, data_G, and data_B by the levels of data voltages every ⅓ horizontal time ⅓H through output channels CH1 to CHn.

In addition, the data driver 140 may output a display data voltage for image expression and an initialization data voltage for initializing the source nodes of the subpixels through the output channels CH1 to CHn at the same time.

As described above, the data driver 140 may alternately output the display data voltage and the initialization data voltage through at least two adjacent output channels, and may include a circuit for outputting the voltages. The display data voltage may be a data voltage applied through a first data line DL1 connected to the first subpixel, and the initialization data voltage may include a data voltage applied through a second data line DL2 connected to a second subpixel adjacent to the first subpixel. In addition, the data driver 140 may operate in connection with the timing controller or may be controlled by the timing controller to output the data voltage in the form described above.

The present disclosure has the effects of reducing the manufacturing cost of a display device by eliminating a voltage generation circuit that generates and outputs an initialization voltage and achieving both an improved aperture ratio and a reduced bezel size by eliminating voltage lines for applying the initialization voltage to a display panel or reducing the number of voltage lines.

It will be apparent to those skilled in the art that various modifications and variations can be made in the present disclosure without departing from the spirit or scope of the present disclosure. Thus, it is intended that the present disclosure cover the modifications and variations of the present disclosure provided they come within the scope of the appended claims and their equivalents.

What is claimed is:

1. A display device, comprising:
a display panel configured to display an image;
a gate driver connected to gate lines of the display panel; and
a data driver connected to data lines of the display panel,
wherein the display panel is configured to operate in a period during which a display data voltage is stored based on three scan signals sequentially applied through three scan lines included in one gate line during one horizontal time, and a source node is initialized based on an initialization data voltage.

2. The display device of claim 1, wherein the display panel includes a first subpixel for storing the display data voltage and initializing the source node based on the initialization data voltage, and
wherein the display data voltage is a data voltage applied through a first data line connected to the first subpixel, and the initialization data voltage includes a data voltage applied through a second data line connected to a second subpixel adjacent to the first subpixel.

3. The display device of claim 1, wherein the display panel includes a first pixel including four subpixels connected to second and third scan lines among the three scan lines, and a second pixel including four subpixels connected to a first scan line and a second scan lines among the three scan lines.

4. The display device of claim 3, wherein the first pixel includes a first subpixel connected to the second scan line and connected to a first data line and a third data line, a second subpixel connected to the second scan line and connected to a second data line and a fourth data line, a third subpixel connected to the third scan line and connected to the third data line and the first data line, and a fourth subpixel connected to the third scan line and connected to the fourth data line and the second data line.

5. The display device of claim 4, wherein the first subpixel stores the display data voltage applied through the first data line in a capacitor and initializes a source node based on the initialization data voltage applied through the third data line,
wherein the second subpixel stores the display data voltage applied through the second data line in a capacitor and initializes a source node based on the initialization data voltage applied through the fourth data line,
wherein the third subpixel stores the display data voltage applied through the third data line in a capacitor and initializes a source node based on the initialization data voltage applied through the first data line, and
wherein the fourth subpixel stores the display data voltage applied through the fourth data line in a capacitor and initializes a source node based on the initialization data voltage applied through the second data line.

6. The display device of claim 3, wherein the second pixel includes a first subpixel connected to the first scan line and connected to a first data line and a third data line, a second subpixel connected to the first scan line and connected to a second data line and a fourth data line, a third subpixel connected to the second scan line and connected to the third data line and the first data line, and a fourth subpixel connected to the second scan line and connected to the fourth data line and the second data line.

7. The display device of claim 1, wherein the display panel includes:
a red subpixel and a green subpixel configured to start operation during a first period of time for which a first scan signal is applied;
a red subpixel, a green subpixel, a blue subpixel, and a white subpixel configured to start operation during a second period of time for which a second scan signal is applied; and
a blue subpixel and a white subpixel configured to start operation during a third period of time for which a third scan signal is applied.

8. A method of driving a display device, comprising:
applying a first scan signal through a first scan line included in one gate line and driving a first subpixel and a second subpixel included in a second pixel;
applying a second scan signal through a second scan line included in the gate line and driving a first subpixel and a second subpixel included in a first pixel and a third subpixel and a fourth subpixel included in the second pixel; and
applying a third scan signal through a third scan line included in the gate line and driving a third subpixel and a fourth subpixel included in the first pixel,
wherein the first pixel and the second pixel store a display data voltage based on the first scan signal, the second scan signal, and the third scan signal sequentially applied for one horizontal time and initialize a source node based on an initialization data voltage.

9. The method of claim 8, wherein the display data voltage is a data voltage applied through a first data line, and the initialization data voltage includes a data voltage applied through a second data line adjacent to the first data line.

10. The method of claim 8, wherein the first pixel includes a first subpixel connected to the second scan line and connected to a first data line and a third data line, a second subpixel connected to the second scan line and connected to a second data line and a fourth data line, a third subpixel connected to the third scan line and connected to the third data line and the first data line, and a fourth subpixel connected to the third scan line and connected to the fourth data line and the second data line.
